(19) United States
(12) Patent Application Publication
(10) Pub. No.: US 2023/0169309 A1
(43) Pub. Date: Jun. 1, 2023

(54) KNOWLEDGE GRAPH CONSTRUCTION METHOD FOR ETHYLENE OXIDE DERIVATIVES PRODUCTION PROCESS

(71) Applicant: DALIAN UNIVERSITY OF TECHNOLOGY, Dalian (CN)

(72) Inventors: Xin YANG, Dalian (CN); Xiaopeng WEI, Dalian (CN); Li ZHU, Dalian (CN); Xirong XU, Dalian (CN); Chenming DUAN, Dalian (CN)

(21) Appl. No.: 17/992,775

(22) Filed: Nov. 22, 2022

(30) Foreign Application Priority Data
Nov. 30, 2021 (CN) 202111443714.6

(51) Int. Cl. G06N 3/042; G06N 3/0442

(52) U.S. Cl. CPC G06N 3/042; G06N 3/0442

(57) ABSTRACT

The present invention belongs to the technical field of knowledge graph, and provides a knowledge graph construction method for an ethylene oxide derivatives production process. According to data types and characteristics, data sources of the ethylene oxide derivatives production process are sorted and divided into three types: structural data, unstructured data and other types of data. An ontology layer and a data layer of a knowledge graph are constructed by combining top-down and bottom-up methods. A data-driven incremental ontology modeling method is proposed to ensure the expandability of the knowledge graph. For structural knowledge extraction, the safety of original data storage is ensured by means of virtual knowledge graph, and a new mapping mechanism is proposed to realize data materialization. For unstructured knowledge extraction, an entity extraction task is realized on the basis of a BERT-BiLSTM-CRF named entity recognition model by integrating a pre-training language model BERT.

### TECHNICAL FIELD

The present invention belongs to the technical field of knowledge graph, particularly relates to a knowledge extraction method for different data sources in the ethylene oxide derivatives production process, and proposes a knowledge graph construction method for the production process in the fine chemical industry.

### BACKGROUND

The field of fine chemical industry is one of the most dynamic emerging fields in the chemical industry at present. In recent years, the fine chemical industry in China is in a period of rapid development, and because of the particularities such as wide varieties, small scale and high standard requirements of products, the production process in the fine chemical industry has complicated technology and high safety risk. How to improve the safety risk control measures of fine chemical industry production is an essential safety management problem to be solved urgently, which has important theoretical significance and impending practical significance.

The safety production data of ethylene oxide derivatives (EOD) as the major products in the fine chemical industry have the characteristics of diversification of sources, complicated structure and correlation. First, the safety monitoring and decision-making of ethylene oxide derived fine chemicals involve a variety of information, including instrument measurement, image monitoring, fault database, fault tracking report, safety check report and safety state analysis, with a large amount of data; second, the data types are complex, with structural, unstructured and semi-structured forms and without unified semantic expression, leading to inadequate understanding and inaccurate description of production safety knowledge; and third, the data flow includes production, quality, inventory, maintenance, energy consumption and other links, the information of which is often collected and disposed independently, resulting in data dispersion, thus leading to cumbersome data collection and low decision-making efficiency as well as inability to make full use of related safety production information.

Therefore, it is urgent to solve the problem of information silo in the processes of fusing and correlating safety production information, rule knowledge and experiential knowledge from multiple sources, constructing a safe production knowledge system for equipment, process devices and operation and opening up fine chemical industry enterprises in the art and provide comprehensive data sources for safety production analysis and control of ethylene oxide derivatives. In view of the above problem, the present invention proposes a knowledge graph construction method for an ethylene oxide derivatives production process. The background of knowledge graph construction will be introduced below in detail.

Knowledge graph is a large-scale semantic network and an important technology for constructing and excavating information correlation. Compared with traditional structural data processing tools, the knowledge graph has the advantages in feature extraction, content retrieval, and representation and reasoning of unstructured and semi-structured data. Compared with traditional knowledge engineering methods, the knowledge graph can realize the construction of large-scale knowledge bases by means of automatic construction and crowdsourcing and has good expandability.

For multi-source heterogeneous data, the intellectualization of each data source requires a means of integrating different technologies. The basic process of knowledge graph construction is as follows: firstly, a knowledge representation model is determined to realize the definition of an ontology layer. Next, different knowledge extraction methods are selected according to data sources to import knowledge. For unstructured data, it is necessary to integrate natural language processing technologies such as named entity recognition, relation extraction and event extraction to realize unstructured knowledge extraction. For structural data, it is necessary to define semantic mapping between data and an ontology model to realize structural knowledge extraction. For semi-structured data, it is necessary to extract information by means of a wrapper. Finally, the quality of constructed knowledge graph is improved by comprehensive use of knowledge-based inference, knowledge fusion and other technologies.

The deep integration of the knowledge graph technology and various industries has become an important trend. The fine chemical industry has obtained and stored a large amount of industrial data, but the industrial data does not create a value of “1+1≥2” due to the lack of intelligent means. It has become an increasingly clear path for industry intelligence to refine, extract, associate and integrate data to form domain knowledge through the knowledge graph technology and build knowledge engine to realize knowledge application automation.

### SUMMARY

Aiming at the knowledge management task in the ethylene oxide derivatives production process scenario, the present invention proposes a complete, accurate and efficient knowledge graph construction technology in the field of fine chemical industry.

The technical solution of the present invention is as follows:

A knowledge graph construction method for an ethylene oxide derivatives production process, comprising the following steps:

(1) Sorting of Data Sources

The present invention covers the following six types of data of the ethylene oxide derivatives (EOD) production process: the first is EOD flow charts and PID drawings, which describe the EOD process flow and corresponding positions of monitoring points in the flow in detail; the second is process measurement data of a distributed control system (DCS), i.e., monitoring points, used for monitoring the process variable state of the production line in real time; the EOD production line has three types of process measurement data: pressure, temperature and flow rate; the third is DCS post operation record tables, which record the monitoring and operation behaviors of staff on duty for each link of the EOD production line; the fourth is process control conditions of EOD devices, which describe the process control range of each link and each piece of equipment of the EOD production line; the fifth is safety interlocking rules in a safety instrumented system (SIS), used for the safety interlocking shut down of devices; and the sixth is a hazard and operability study (HAZOP) report, which records the states of abnormal behaviors, triggering conditions, consequences, treatment schemes and pre-treatment measures in the EOD production process.

For the above six types of data, the knowledge graph construction process for the EOD production process is divided into two parts: construction of an ontology layer and acquisition of a data layer; and the ontology layer and the data layer are constructed by a combination of top-down and bottom-up methods.

(2) Knowledge Modeling Based on Ontology

The construction of the ontology layer is to abstract the concept hierarchical structure from the EOD domain and define the related attributes, relations and axiom criteria of each concept. Since a lot of multi-modal data exists in the actual factory, data sources involved in the present invention are only a part of data generated in the EOD production process. Therefore, a data-driven incremental ontology modeling method is proposed to construct the ontology layer step by step and improve the definition of the concept level, which ensures the expandability of the knowledge graph. Meanwhile, the OWL language is used for knowledge representation and axiom design of the ontology layer. In the present invention, an ontology model is defined as:

O=<C,R,A,E,F>

wherein O: an ontology model of EOD;
C: an ontology or class, meaning a collection of entity objects or concepts of the same class;

R: logical relation, meaning the semantic relation between ontologies;
A: attribute relation, meaning attributes possessed by the ontologies and attribute values;

E: entity, meaning instantiation of the ontologies;
F: function or axiom, a description logic used for representing the complex relation between the ontologies;

Based on the definition of the above ontology model, an ontology with the EOD production process as the core for six interrelated domains including equipment structure domain, device structure domain, system structure domain, risk cause domain, risk class domain and maintenance measure domain is constructed. The ontology system is divided by a top-down method, and the attribute relation of the ontology is defined, so as to build the ontology layer framework of the EOD knowledge graph; and meanwhile, the process control conditions of EOD devices and the SIS safety interlocking rules are expressed in the form of axioms, and then the attributes of related entities are constrained so that the ontology model of EOD has a reasoning mechanism.

Since the construction of a knowledge graph is an iterative updating process, the fusion of new knowledge will not only fill the data layer, but also continuously improve the ontology layer framework. Therefore, through knowledge extraction of multi-source data, related concepts and attributes of the ontology layer are refined and completed by a bottom-up method.

(3) Structural Knowledge Extraction Based on DCS Database

The DCS database stores the historical data about the monitoring points of the EOD production line in a relational database. During knowledge extraction of structural data, in order to avoid repeated redundancy of data, virtual mapping is carried out to the data in the DCS database by means of virtual knowledge graph, so as to support direct access to the relational database in the form of accessing to the knowledge graph.

The method proposes a new mapping mechanism to realize structural knowledge extraction. The DCS database design mode is to use id numbers, i.e., monitoring points, as attributes or fields of a relation table. Therefore, first, the definition of the related concepts and attributes of the ontology layer is refined on the basis of the knowledge modeling in step (2) according to the design mode of the relational database, and then, triplet mapping is realized through the mapping rules. Based on the purpose of materializing each piece of historical data of the monitoring sample points, a new mapping rule is designed: attributes in the relation table are defined as ontologies in the knowledge graph, including time ontology and bit number ontology. The attribute values in the relation table exist as entities in the knowledge graph, and each sensor entity has a timestamp attribute to connect the corresponding time entity, as follows:

ex:EOD/DCS/{PI-3175} a: Monitoring point

ex:EOD/DCS/{TIME} a: Time point

ex:EOD/DCS/{PI-3175} Time Stamp {TIME}

wherein ex represents the namespace of the EOD knowledge graph, each attribute value with the attribute of PI-3175 in the DCS database is linked to the monitoring ontology of the knowledge graph as an entity, each attribute value with the attribute of TIME is linked to the time point ontology as an entity, and each monitoring point entity is associated with the corresponding time entity through a Time Stamp object attribute.

In addition to production data in the DCS database, the DCS post operation record table is also stored on the corresponding system platform in a structural form, recording the monitoring and operation behaviors of staff in the inspection process, and the knowledge extraction of this part of structural data is realized through the same mapping method. Therefore, a staff ontology is defined at the ontology layer, and the staff ontology has logical attributes of job number, service position, on-duty time and production operation. Then the related attributes and attribute values in the record table are successively mapped to the knowledge graph, and the related attributes include initiation of feeding, initiation of deaeration, entry of neutralizer, and cooling.

(4) Unstructured Knowledge Extraction Based on HAZOP Report

The HAZOP report includes description of a large number of abnormal events such as accidental states, causes, consequences and treatment measures in the EOD production process. Because the HAZOP report is presented in unstructured text, the natural language processing technology is required to extract knowledge from the text. The present invention adopts the named entity recognition (NER) technology for unstructured knowledge extraction, and the entities to be extracted include chemicals, accidents and equipment.

First, related statements are extracted from the HAZOP for data annotation, and data annotation is carried out in a BIO format, where B represents the first word of an entity, I represents the middle part of an entity, and O represents a non-entity. The related entities of data sets are annotated as B-CHE, B-ACC, B-EQU, I-CHE, I-ACC and I-EQU, and non-entities are annotated as O. The annotated data sets are divided into training data, test data and validation data in a proportion of 8:1:1

Then a BERT+BiLSTM+CRF model is used as a named entity recognition model for training and validation. The model is composed of a Bert module, a BiLSTM module and a CRF module.

The first layer of the model carries out word embedding by using the BERT pre-training model to effectively extract semantic features from the text. The network architecture of BERT is a multi-layer Transformer structure, which is essentially to learn a good feature representation for words through unsupervised training on the basis of massive corpus, better integrate the knowledge of the context and learn a large number of prior languages, syntax, word meaning and other information for downstream tasks.

The second layer of the model is a bidirectional LSTM layer, and the embedding vector acquired by the first layer is taken as the input of each time step of the second layer of LSTM. LSTM is composed of three gate controls:

Forget gate: fₜ=σ(W_{f}·[hₜ₋₁,xₜ]+b_{f}) \textcircled{1}
wherein hₜ₋₁ is the hidden state at the previous moment, xₜ is the input information at the current moment, W_{f} is a weight matrix, b_{f} is a bias, and σ is an activation function;

Input gate: iₜ=σ(Wᵢ·[hₜ₋₁,xₜ]+bᵢ) \textcircled{2}
Thus, the cell state at the current moment is obtained: \tilde{C}ₜ=tan h(W_{c}·[hₜ₋₁,xₜ]+b_{c})

Cₜ=fₜ*Cₜ₋₁+iₜ*\tilde{C}ₜ
wherein Wᵢ is a weight matrix, bᵢ is a bias, W_{c} is a weight matrix, b_{c} is a bias term, and Cₜ₋₁ is the cell state at the previous moment;

Output gate: Oₜ=σ(Wₒ·[hₜ₋₁,xₜ]+b₀) \textcircled{3}

hₜ=Oₜ*tan h(Cₜ)

The input text information obtains hidden state sequences [symbol] (forward) and [symbol] (backward) in both the forward and backward directions, and finally, the final hidden state sequence hₜ is obtained through concatenating.

At the third layer of the model, hₜ of the second layer is mapped to a k-dimension (the number of tag classes annotated in the data set) through a linear output layer to obtain the probability that each word belongs to each class tag. Finally, the score function is calculated through the CRF layer, the tag sequence with the maximum probability is output as a prediction result, and the score function is defined as follows:

$$S ( X , y ) = {\sum }_{i = 0}^{n} {A}_{{y}_{i} , {y}_{i + 1}} + {\sum }_{i = 1}^{n} {P}_{i , {y}_{i}}$$

$$P ( y \vert X ) = \frac{{e}^{s ( X , y )}}{{\sum }_{\tilde{y} ∈ {Y}_{x}} {e}^{s ( X , \tilde{y} )}}$$

wherein P_{i,y}_{ᵢ} represents the non-normalized probability of the mapping of a word xᵢ to a tag yᵢ in text information, a transition matrix A_{y}_{ᵢ}_{,y}_{ᵢ₊₁} represents the transition probability from tags yᵢ to yᵢ₊₁, the score function S(X, y) is obtained by summing the tag probability matrix of all the words xᵢ and the transition matrix, and then the probability P(y|X) that the input sequence belongs to a tag sequence is obtained by normalization with the softmax function. The sequence with the maximum probability is taken as the prediction result of the model.

The present invention has the following beneficial effects:

(1) Ontology Construction Method by Combination of Top-Down and Bottom-Up

The present invention combines the data characteristics of the EOD production line and constructs the ontology layer framework from top-down by manually summarizing and concluding concepts with the production process as the core. At the same time, considering that the factory data has multiple dispersed sources and complicated structure, it is impossible to extract all knowledge at one time. Therefore, an iterative and incremental method is adopted to abstract step by step from bottom-upto generate the top-level concept through the continuous acquisition of multi-modal data, and improve and expand the ontology layer framework.

(2) New Structural Knowledge Extraction Mapping Rule

In Order to Map Structural Data as Entities to the Knowledge Graph so as to Better associate with other data entities and avoid the redundancy and complexity of entities, the present invention breaks the traditional database mapping rules, materializes each piece of data and ontologizes each column of attributes in the database, and provides a new mapping method for EOD structural knowledge extraction. Meanwhile, structural knowledge extraction is realized by means of virtual knowledge graph, which avoids the problem of exposing the original data source to the end user through knowledge graph and ensures the security of data stored in the original factory system. The integrated data is equivalent to a view on the original data, and generally does not need to be solidified, but can be kept virtual. In this way, the time and extra storage space for solidifying view data are reduced, which makes data integration more efficient and flexible and extendable.

(3) Effectiveness of Unstructured Knowledge Extract Model

The named entity recognition model BERT-BiLSTM-CRF adopted by the present invention makes use of the powerful feature extraction ability of BERT, and the extraction of word embedding features is obtained through pre-training +fine-tune of BERT, which solves the problem of poor text information extraction effect caused by less NER annotation data. Meanwhile, during data annotation of the present invention, each word corresponds to a tag so that the tags predicted after passing through the BiLSTM layer are independent. Considering the consistency of tag prediction within the entities, CRF is used to calculate the global optimum of the whole tag sequence, so as to realize entity recognition.

### DESCRIPTION OF DRAWINGS

FIG. 1 is a frame diagram of an overall flow for construction of an EOD knowledge graph of the present invention.

FIG. 2 is a frame diagram of an ontology layer of the present invention.

FIG. 3 is a model diagram for unstructured knowledge extraction of the present invention.

### DETAILED DESCRIPTION

Specific embodiments of the present invention are further described below in combination with accompanying drawings and the technical solution.

The data used in the embodiment is the related data of the EOD production process, and six data sources are collected and analyzed in total. According to different data types and characteristics, the data can be divided into structural data, unstructured data and other types of data. According to the types and uses of the data, knowledge modeling and knowledge extraction are respectively carried out by the corresponding methods proposed by the present invention.

The ontology layer of a knowledge graph is constructed with the EOD production process as the core. First, the EOD production line is sorted, including production links, production equipment, sensor equipment and materials, related concepts are abstracted and classified, the ontology layer is constructed by the OWL language, and the logical attributes of the ontology are designed according to the process control conditions of EOD. For example:
\textcircled{1} Subclass declaration. Declaring the subgenus relation of two classes. For example:

exp: safety risk owl: subclass exp: ethylene oxide derivatives production line

exp: post-treatment owl: subclass exp: process flow
\textcircled{2} Equivalence declaration. Declaring that two classes, attributes and instances are equivalent. For example:
   exp: ethylene oxide derivatives owl: equivalent Class exp: EOD
   exp: hazard and operability study owl: equivalent Class exp: HAZOP
   exp: isobutenol polyoxyethylene ether owl: equivalent Class exp: HPEG
\textcircled{3} Declaration of inverse attributes. Declaring that two attributes have an inverse relation. For example:
   exp:ConnectTo owl:inverseOf exp:ConnectFrom
\textcircled{4} Declaration of attribute range. Declaring the object ranges of the subject and predicate of an attribute. For example:
   exp:reactant rdfs:domain exp:chemical
   exp:reactant rdfs:range exp:chemical reaction
   exp: normal temperature range of V-2110 storage tank rdfs:range exp:20-110

The powerful semantic expression ability of OWL makes it possible to define complex axiomatic criteria and use the reasoning mechanism to conduct forward chain reasoning based on the axiom criteria. For example, during the EOD production process, when multiple anomalies occur, the SIS system will be interlocked urgently to prevent major accidents. The safety interlocking rules designed by the SIS system can be expressed by the axioms of OWL:
PSHH-3204 some xsd:integer[>=700] and
TSHHH-3202 some xsd:integer[>=205]

wherein the above language imposes attribute constraints on a safety interlocking rule entity. When the interlocking values of the above two ids PSHHH-3204 and TSHH-3202 exceed the threshold, the safety interlocking rule entity is triggered: close the EOD feed line valve.

The construction of the data layer of the knowledge graph adopts the method of structural knowledge extraction and unstructured knowledge extraction to add the EOD production process data to the knowledge base. Structural data such as DCS database and DCS post operation record table is mapped to the corresponding ontology layer by means of virtual knowledge graph. First, the design mode of the database in the factory is determined, including attributes and domains of each data table, each attribute is defined as an ontology, and each domain is defined as the logical attribute of the ontology; and then OBDA systems (ontology-based database access system) such as Ontop are used to design mapping rules, and finally, data mapping is completed.

The unstructured data such as HAZOP report in the form of text basically covers materials, accidents, equipment and other information involved in EOD production, and related entities are automatically extracted by the named entity recognition (NER) technology and linked to the knowledge graph. Firstly, the text data is annotated verbatim in the BIO format, and the annotated data is divided into training data, test data and validation data. Finally, the vectorized corpus samples of the officially issued Bert trained model chinese_L-12_H-768_A-12 are input into the built BiLSTM+CRF model for model training, test and validation.

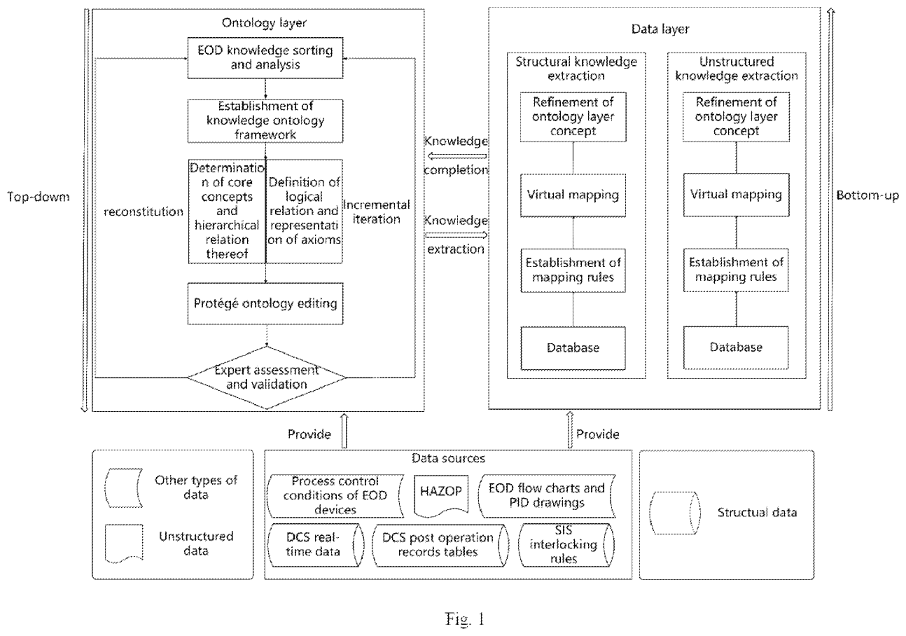

FIG. 1 is a frame diagram of an overall flow for construction of EOD knowledge graphs of the present invention. The construction of the EOD knowledge graph is divided into two parts: construction of an ontology layer and construction of a data layer. The ontology layer constantly expands the ontology framework in an incremental and iterative mode by a combination of top-down and bottom-up methods. The knowledge modeling tool is an ontology editing and ontology development tool—Protégé which is developed based on Java language at the Stanford Center for Biomedical Informatics Research. The data source of the data layer is mainly structural data and unstructured data, knowledge extraction is realized respectively by means of virtual mapping and named entity recognition, the data is added to the knowledge base, and the knowledge system of the ontology layer is improved.

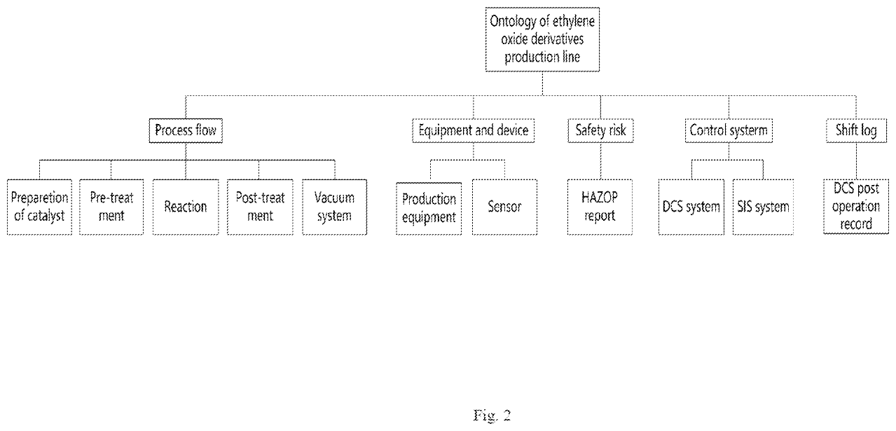

FIG. 2 is a frame diagram of an ontology layer of the present invention. By sorting the data sources, the related knowledge of the EOD production process is analyzed and classified by a top-down method, and the top-level ontology framework shown in the figure is defined. The EOD production process is mainly divided into five classes, i.e., top-level ontologies: process flow, equipment and device, security risk, control system and shift log. Then, the related concepts are refined on the basis of the five classes, and the concept of data entities is abstracted through knowledge extraction of different data sources, so as to constantly improve and supplement the ontology layer framework.

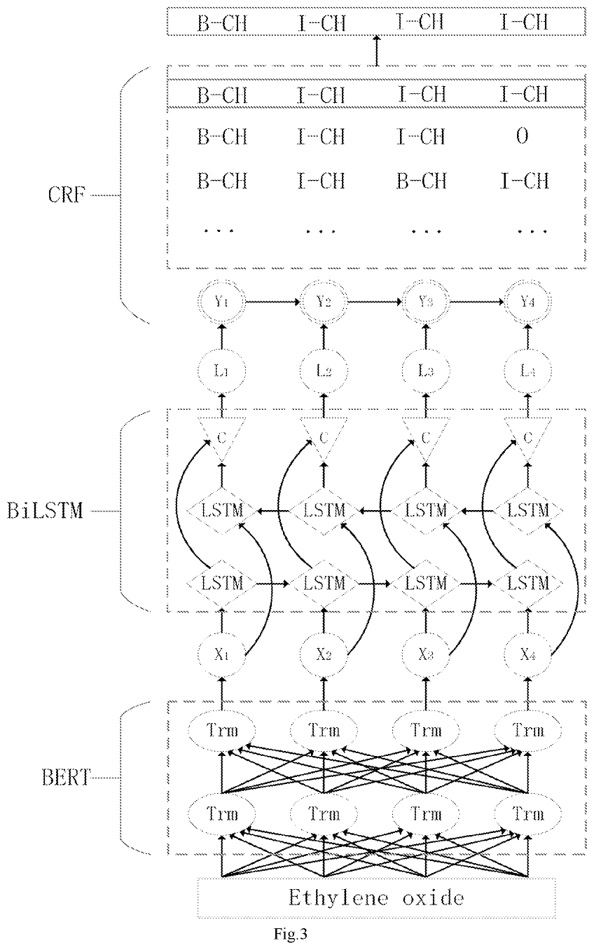

FIG. 3 is a model diagram for unstructured knowledge extraction of the present invention. The model uses the powerful pre-training language model—BERT model as the word embedding module to extract abundant semantic information features from the text. BERT is composed of a multi-layer Transformer structure, with one Trm corresponding to one Transformer block in the figure. Then the word vector obtained by the BERT module is input into the BiLSTM module to learn the context feature information so as to obtain the non-normalized probability that each word belongs to each class tag. Finally, the probability value of each tag sequence is calculated through the CRF layer, and the sequence with the highest score is taken as the output of the model.

1. A knowledge graph construction method for an ethylene oxide derivatives production process, comprising the following steps:
(1) data sorting
the ethylene oxide derivatives (EOD) production process includes six types of data: 1) EOD flow charts and PID control charts, used for describing the EOD process flow and corresponding positions of monitoring points in the flow; 2) process measurement data of a distributed control system (DCS), i.e., monitoring points, used for monitoring the process variable state of the production line in real time, wherein the EOD production line has three types of process measurement data: pressure, temperature and flow rate; 3) DOS post operation record tables, used for recording the monitoring and operation behaviors of staff on duty for each link of the EOD production line; 4) process control conditions of EOD devices, used for describing the process control range of each link and each piece of equipment of the EOD production line; 5) safety interlocking rules in a safety instrumented system (SIS), used for the safety interlocking shut down of devices; and 6) a hazard and operability study (HAZOP) report, used for recording the states of abnormal behaviors, triggering conditions, consequences, treatment schemes and pre-treatment measures in the EOD production process;
for the above six types of data, the knowledge graph construction process for the EOD production process is divided into two parts: construction of an ontology layer and acquisition of a data layer; and the ontology layer and the data layer are constructed by a combination of top-down and bottom-up methods;
(2) knowledge modeling based on ontology
the construction of the ontology layer is to abstract the concept hierarchical structure from the EOD domain and define the related attributes, relations and axiom criteria of each concept; comprehensively considering the data types and features of the EOD production process, a data-driven incremental ontology modeling method is proposed to construct the ontology layer step by step, and the OWL language is used to represent knowledge and design axioms for the ontology layer; and an ontology model is defined as:
O=<C,R,A,E,F>
wherein O: an ontology model of EOD;
C: an ontology or class, meaning a collection of entity objects or concepts of the same class;
R: logical relation, meaning the semantic relation between ontologies;
A: attribute relation, meaning attributes possessed by the ontologies and attribute values;
E: entity, meaning instantiation of the ontologies;
F: function or axiom, a description logic used for representing the complex relation between the ontologies;
based on the definition of the above ontology model, an ontology with the EOD production process as the core for six interrelated domains including equipment structure domain, device structure domain, system structure domain, risk cause domain, risk class domain and maintenance measure domain is constructed; the ontology system is divided by a top-down method, and the attribute relation of the ontology is defined, so as to build the ontology layer framework of the EOD knowledge graph; and meanwhile, the process control conditions of EOD devices and the SIS safety interlocking rules are expressed in the form of axioms, and then the attributes of related entities are constrained so that the ontology model of EOD has a reasoning mechanism;
since the construction of a knowledge graph is an iterative updating process, the fusion of new knowledge will not only fill the data layer, but also continuously improve the ontology layer framework; and therefore, through knowledge extraction of multi-source data, related concepts and attributes of the ontology layer are refined and completed by a bottom-up method;
(3) structural knowledge extraction based on DCS database
the DCS database stores the historical data about the monitoring points of the EOD production line in a relational database; and during knowledge extraction of structural data, in order to avoid repeated redundancy of data, virtual mapping is carried out to the data in the DCS database by means of virtual knowledge graph, so as to support direct access to the relational database in the form of accessing to the knowledge graph;
the method proposes a new mapping mechanism to realize structural knowledge extraction; the DCS database design mode is to use id numbers, i.e., monitoring points, as attributes or fields of a relation table; therefore, first, the definition of the related concepts and attributes of the ontology layer is refined on the basis of the knowledge modeling in step (2) according to the design mode of the relational database, and then, triplet mapping is realized through the mapping rules; based on the purpose of materializing each piece of historical data of the monitoring sample points, a new mapping rule is designed: attributes in the relation table are defined as ontologies in the knowledge graph, including time ontology and id number ontology; and the attribute values in the relation table exist as entities in the knowledge graph, and each id number entity has a timestamp attribute to connect the corresponding time entity, as follows:
ex:EOD/DCS/{PI-3175} a: monitoring sample point
ex:EOD/DCS/{TIME} a: time point
ex:EOD/DCS/{PI-3175} Time Stamp {TIME}
wherein ex represents the namespace of the EOD knowledge graph, each attribute value with the attribute of PI-3175 in the DCS database is linked to the monitoring point ontology of the knowledge graph as an entity, each attribute value with the attribute of TIME is linked to the time point ontology as an entity, and each monitoring point entity is associated with the corresponding time entity through a Time Stamp object attribute;
in addition to production data in the DCS database, the DCS post operation record table is also stored on the corresponding system platform in a structural form, recording the monitoring and operation behaviors of staff in the inspection process, and the knowledge extraction of this part of structural data is realized through the same mapping method; therefore, a staff ontology is defined at the ontology layer, and the staff ontology has logical attributes of job number, service position, on-duty time and production operation; and then the related attributes and attribute values in the record table are successively mapped to the knowledge graph, and the related attributes include initiation of feeding, initiation of deaeration, entry of neutralizer, and cooling;
(4) unstructured knowledge extraction based on HAZOP report
the HAZOP report includes description of abnormal events such as accidental states, causes, consequences and treatment measures in the EOD production process; and the named entity recognition (NER) technology is adopted for unstructured knowledge extraction, and the entities to be extracted include Chemical, Accident and Equipment;
first, related statements are extracted from the HAZOP report for data annotation, and data annotation is carried out in a BIO format, where B represents the first word of an entity, I represents the middle part of an entity, and O represents a non-entity; the related entities of data sets are annotated as B-CHE, B-ACC, B-EQU, I-CHE, I-ACC and I-EQU, and non-entities are annotated as O; and the annotated data sets are divided into training data, test data and validation data in a proportion of 8:1:1;
then a BERT+BiLSTM+CRF model is used as a named entity recognition model for training and validation, and the model is composed of a Bert module, a BiLSTM module and a CRF module;
the first layer of the model carries out word embedding by using the BERT pre-training model to extract semantic features from the text; and the network architecture of BERT is a multi-layer Transformer structure;
the second layer of the model is a bidirectional LSTM layer, and the embedding vector acquired by the first layer is taken as the input of each time step of the second layer of LSTM; and LSTM is composed of three gate controls:
forget gate:fₜ=σ(W_{f}·[hₜ₋₁,xₜ]+b_{f}) \textcircled{4}
wherein hₜ₋₁ is the hidden state at the previous moment, xₜ is the input information at the current moment, W_{f} is a weight matrix, b_{f} is a bias, and σ is an activation function;
input gate: iₜ=σ(Wᵢ·[hₜ₋₁,xₜ]+bᵢ) \textcircled{5}
thus, the cell state at the current moment is obtained: \tilde{C}ₜ=tan h(W_{c} ·[hₜ₋₁, xₜ]+b_{c})
Cₜ=fₜ*Cₜ₋₁+iₜ*\tilde{C}ₜ
wherein Wᵢ is a weight matrix, bᵢ is a bias, W_{c} is a weight matrix, b_{c} is a bias term, and Cₜ₋₁ is the cell state at the previous moment;
output date: Oₜ=σ(W₀·[hₜ₋₁,xₜ]+b₀) \textcircled{6}
hₜ=Oₜ*tan h(Cₜ)
the input text information obtains hidden state sequences [symbol] and [symbol] in both the forward and backward directions, and finally, the final hidden state sequence hₜ is obtained through concatenating;
the third layer of the model is a CRF layer, hₜ of the second layer is mapped to a k-dimension, i.e., the number of tag classes annotated in the data set, through a linear output layer to obtain the probability that each word belongs to each class tag, and finally, the score function is calculated through the CRF layer, the tag sequence with the maximum probability is output as a prediction result, and the score function is defined as follows:
$$S ( X , y ) = {\sum }_{i = 0}^{n} {A}_{{y}_{i} , {y}_{i + 1}} + {\sum }_{i = 1}^{n} {P}_{i , {y}_{i}}$$
$$P ( y \vert X ) = \frac{{e}^{s ( X , y )}}{{\sum }_{\tilde{y} ∈ {Y}_{x}} {e}^{s ( X , \tilde{y} )}}$$
wherein P_{i,y}_{ᵢ} represents the non-normalized probability of the mapping of a word xᵢ to a tag yᵢ in the text information, a transition matrix A_{y}_{ᵢ}_{,y}_{ᵢ₊₁} represents the transition probability from tags yᵢ to yᵢ₊₁, the score function S(X, y) is obtained by summing the tag probability matrix of all the words xᵢ and the transition matrix, and then the probability P(y|X) that the input sequence belongs to a tag sequence is obtained by normalization with the softmax function; and the sequence with the maximum probability is taken as the prediction result of the model.
